(19) United States
(12) Patent Application Publication
(10) Pub. No.: US 2024/0199501 A1
(43) Pub. Date: Jun. 20, 2024

(54) USE OF FOAM MORTAR AS ADHESIVE FOR FLOORINGS

(71) Applicant: WACKER CHEMIE AG, Munich (DE)

(72) Inventors: Holger BIENERTH, München (DE); Josef BRUMMER, Simbach (DE); Klaus-Jürgen EDER, Mitterskirchen (DE); Harald ZEH, Burghausen (DE)

(73) Assignee: Wacker Chemie AG, Munich (DE)

(21) Appl. No.: 18/288,835

(22) PCT Filed: May 10, 2021
(86) PCT No.: PCT/EP2021/062371

§ 371 Date: Oct. 30, 2023

(51) Int. Cl. C04B 38/10; C04B 7/32; C04B 22/10; C04B 24/26; C04B 28/06; C04B 103/30; C04B 103/48; C04B 111/00; C04B 111/40; C04B 111/60

(52) U.S. Cl. CPC C04B 38/10; C04B 7/323; C04B 22/10; C04B 24/2623; C04B 28/065; C04B 2103/304; C04B 2103/48; C04B 2111/00646; C04B 2111/40; C04B 2111/60

(57) ABSTRACT

Use of a foam mortar as a bonding agent for floorings, includes the foam mortar containing protective colloid-stabilized polymers of ethylenically unsaturated monomers.

The invention relates to the use of foam mortar as a bonding agent for floorings, especially as a tile adhesive for ceramic tiles, natural stone tiles or glass tiles, and to methods for laying floorings.

In the building sector, there is increasingly demand for more environmental construction technologies, involving, for example, the replacement of conventional building materials by renewable building materials or those obtained in a less energy-intensive process, or by using building materials in a manner that saves on resources. At the same time, the building products must continue to meet the building material standards and have advantageous performance properties. For instance, floorings bonded to a floor with bonding agents must adhere sufficiently to the substrate under the usual exposures. For example, cementitious tile adhesives are required to meet the C1 standard, corresponding to a tensile adhesion strength of at least 0.5 N/mm². Moreover, bonding agents are also to have advantageous processing qualities, such as a creamy consistency, so that the adhesive can easily be applied ergonomically and has a sufficient open time, and hence floorings laid into the mortar bed, such as tiles, can still readily be corrected.

Against this background, the object was to provide bonding agents for floorings that enable resource-sparing laying of floors while achieving the desired performance properties, such as creamy consistency or open time of the bonding agent, or advantageous tensile adhesion strengths of the floorings bonded with the bonding agent. Particularly when using the bonding agents as tile adhesives, the laid tiles ought to meet the C1 standard according to DIN 12004, corresponding preferably to the attainment of tensile adhesion strengths of at least 0.5 N/mm².

This subject has been achieved, surprisingly, through use of foam mortar as a bonding agent for floorings, said foam mortar comprising protective colloid-stabilized polymers of ethylenically unsaturated monomers.

Foam mortar is generally a bonding agent which implicitly comprises an increased proportion of air pores. On the basis of this air pore content, a particular challenge is involved in achieving the desired mechanical properties with foam mortars, especially tensile adhesion strengths, and at the same time achieving the desired fresh-mortar properties, such as creamy consistency or open time.

Cementitious foams have been employed in the construction industry as insulating material, both for heat insulation and for sound insulation, or else as fire protection material, and are known for example from CN108484211 or CN108529940. DE4209897 and DE3909083 described gypsum-based foam mortars. GB20047636 is concerned with silicate foams. DE2056255 discloses foam compositions for gypsum and cement materials. DE4009967 teaches the use of pore formers in mortar, the pore formers being provided with an inactivating coating, so that the pore-forming effect of the pore formers in the fresh concrete is delayed.

One subject of the invention is the use of foam mortar as a bonding agent for floorings, said foam mortar comprising protective colloid-stabilized polymers of ethylenically unsaturated monomers.

A further subject of the invention are methods for laying floorings, in which floorings are bonded with foam mortar as bonding agent to a substrate, said foam mortar comprising protective colloid-stabilized polymers of ethylenically unsaturated monomers.

Foam mortars are based preferably on one or more foam stabilizers, cement, one or more protective colloid-stabilized polymers of ethylenically unsaturated monomers in the form of aqueous dispersions or water-redispersible powders, one or more air entrainers and optionally one or more additives.

Foam mortars are obtainable, for example, by incorporating air pores, by means of one or more air entrainers, and optionally by introducing air, into aqueous mortars.

Air can be introduced into aqueous mortars by means, for example, of mechanical mixing of the aqueous mortars with air. For this, the aqueous mortars, for example, may be beaten, with air mixed into them. Mechanical mixing takes place preferably by means of stirring blades, mixing coils, paddle stirrers, propeller stirrers or perforated-plate stirrers. Mixing coils with perforated plates are particularly preferred. Foam generators may also be employed. Foam generators are machines available commercially for the generation of foam. The blowing of air into the aqueous mortars is a further possibility. The air preferably has a temperature of 5° C. to 35° C., more particularly ambient temperature.

Preferred air entrainers are ammonium salts or alkali metal salts of hydrogencarbonates or carbonates, more particularly their ammonium or sodium or potassium salts. Hydrogencarbonates are particularly preferred. The most preferred is sodium hydrogencarbonate. The air entrainers preferably do not comprise alkaline earth metal carbonate. Air entrainers have a particle sizing of preferably 10 μm to 1 mm, more preferably of 100 μm to 800 μm and most preferably 200 μm to 700 μm.

The foam mortars are based preferably to an extent of 0.01% to 10% by weight, more preferably 0.5% to 5% by weight and most preferably 0.1% to 3% by weight on air entrainers, relative to the dry weight of the foam mortars.

For example, surfactant-based, polymer-based, protein-based or enzyme-based foam stabilizers may be employed.

Examples of surfactants as foam stabilizers are olefinsulfonic acids; fatty acids, having preferably 16 to 18 carbon atoms, or salts thereof; fatty alcohols, having preferably 10 to 18 carbon atoms; alkylphenols or hydroxyalkylphenols having preferably alkyl chains with 10 to 18 carbon atoms; alkyl and alkylaryl ether sulfates having preferably 8 to 18 carbon atoms in the hydrophobic radical and preferably 1 to 50 ethylene oxide units; sulfonates, especially alkylsulfonates having preferably 8 to 18 carbon atoms, alkylarylsulfonates, preferably having alkyl radicals with 8 to 18 carbon atoms, esters or monoesters of sulfosuccinic acid with preferably monohydric alcohols or alkylphenols having preferably 4 to 15 carbon atoms in the alkyl radical, where these alcohols or alkylphenols may also be ethoxylated with 1 to 40 ethylene oxide units; phosphoric acid partial esters, especially alkyl or alkylaryl phosphates having 8 to 20 carbon atoms in the organic radical, alkyl ether and alkylaryl ether phosphates having 8 to 20 carbon atoms in the alkyl or alkylaryl radical and 1 to 50 EO units; alkyl polyglycol ethers preferably having 8 to 40 EO units and alkyl radicals having 8 to 20 carbon atoms; alkylaryl polyglycol ethers preferably having 8 to 40 EO units and 8 to 20 carbon atoms in the alkyl and aryl radicals; ethylene oxide/propylene oxide (EO/PO) block copolymers preferably having 8 to 40 EO and/or PO units; N-methyltaurides preferably of higher fatty acids, having preferably 10 to 18 carbon atoms; fatty acid alkylolamides, such as mono- or diethanolamides of fatty acids; amine oxides or phosphine oxides, such as cocodimethylamine oxide or cocodimethylphosphine oxide of the general formula R—N(CH₃)₂═O or R—P(CH₃)₂═O; ampholytes, such as sodium cocoyl dimethylaminoacetate or sulfobetaine; phosphoric esters, especially of long-chain alcohols, having preferably 10 to 18 carbon atoms or of alcohols ethoxylated with 1 to 4 mol of ethylene oxide and having 8 to 10 carbon atoms in the molecule.

Preferred surfactants here are olefinsulfonic acids, fatty acids, fatty alcohols, alkyl and alkylaryl ether sulfates and sulfonates.

An EO unit stands for an ethylene oxide unit and a PO unit for a propylene oxide unit. The above-mentioned acids may also be in the form of their salts, especially ammonium or alkali metal or alkaline earth metal salts. Olefinsulfonic acids contain preferably 10 to 20 carbon atoms. The olefinsulfonic acids carry preferably one or two sulfonic or hydroxyalkylsulfonic acid groups. Preferred in this context are α-olefinsulfonic acids.

Examples of polymers as foam stabilizers are polyvinyl alcohols; polyvinylacetals; polyvinylpyrrolidones; polysaccharides in water-soluble form, such as starches (amylose and amylopectin), celluloses and derivatives thereof, such as carboxymethyl, methyl, hydroxyethyl and hydroxypropyl derivatives, dextrins and cyclodextrins; lignosulfonates; poly(meth)acrylic acid; copolymers of (meth)acrylates with carboxyl-functional comonomer units; poly(meth)acrylamide; polyvinylsulfonic acids and water-soluble copolymers thereof; melamine-formaldehyde sulfonates; naphthalene-formaldehyde sulfonates; styrene-maleic acid copolymers and vinyl ether-maleic acid copolymers.

Examples of proteins as foam stabilizers are casein, caseinate, soy protein or gelatin. Proteins are obtainable, for example, by protein hydrolysis, especially of animal proteins, as for example from horn, blood, bone and similar discards from cattle, pigs and other animal carcasses. Enzymes as foam stabilizers may be of biotechnological origin, for example.

Preferred foam stabilizers are surfactants; polyvinyl alcohols; polyvinylpyrrolidones; celluloses and derivatives thereof, such as carboxymethyl, methyl, hydroxyethyl and hydroxypropyl derivatives; proteins such as casein or caseinate, soy protein and gelatin. Particularly preferred foam stabilizers are surfactants, especially olefinsulfonic acids.

Particular preference is given to the joint use of surfactant foam stabilizers and polymer foam stabilizers.

The foam stabilizers have molecular weights of preferably ≤4000 g/mol, more preferably ≤3000 g/mol, more preferably still ≤2500 g/mol, very preferably ≤1500 g/mol and most preferably ≤1000 g/mol.

The foam stabilizers and the protective colloid-stabilized polymers are generally present alongside one another. The foam stabilizers are generally not a constituent of the protective colloid-stabilized polymers.

The foam mortars are based on foam stabilizers to an extent of preferably 0.01% to 35% by weight, more preferably 0.05% to 20% by weight and most preferably from 0.1% to 10% by weight. Surfactants or polymers as foam stabilizers are included preferably at 0.01% to 10% by weight, more preferably 0.05% to 5% by weight and most preferably 0.1% to 3% by weight. Proteins or enzymes as foam stabilizers are included preferably at 10% to 35% by weight, more preferably 15% to 30% by weight and most preferably 20% to 25% by weight. The figures in percent by weight here relate to the dry weight of the foam mortars.

The foam mortars are based on protective colloid-stabilized polymers of ethylenically unsaturated monomers to an extent of preferably 0.5% to 40% by weight, more preferably 5% to 30% by weight and most preferably 10% to 20% by weight, relative to the dry weight of the foam mortars.

The polymers of ethylenically unsaturated monomers are based, for example, on one or more monomers selected from the group encompassing vinyl esters, (meth)acrylic esters, vinylaromatics, olefins, 1,3-dienes and vinyl halides.

Suitable vinyl esters are, for example, those of carboxylic acids having 1 to 15 carbon atoms. Preferred are vinyl acetate, vinyl propionate, vinyl butyrate, vinyl 2-ethylhexanoate, vinyl laurate, 1-methylvinyl acetate, vinyl pivalate und vinyl esters of α-branched monocarboxylic acids having 9 to 11 carbon atoms, as for example VeoVa9R or VeoVa10R (trade names belonging to Resolution). Particularly preferred is vinyl acetate.

Suitable monomers from the group of acrylic esters or methacrylic esters are, for example, esters of unbranched or branched alcohols having 1 to 15 carbon atoms. Preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate, tert-butyl acrylate, tert-butyl methacrylate and 2-ethylhexyl acrylate. Particularly preferred are methyl acrylate, methyl methacrylate, n-butyl acrylate, tert-butyl acrylate and 2-ethylhexyl acrylate.

Preferred vinylaromatics are styrene, methylstyrene and vinyltoluene. A preferred vinyl halide is vinyl chloride. The preferred olefins are ethylene and propylene, and the preferred dienes are 1,3-butadiene and isoprene.

Optionally it is possible for auxiliary monomers to be copolymerized at 0% to 10% by weight, preferably 0.1% to 5% by weight, relative to the total weight of the monomers. Examples of auxiliary monomers are ethylenically unsaturated monocarboxylic and dicarboxylic acids, preferably acrylic acid, methacrylic acid, fumaric acid and maleic acid; ethylenically unsaturated carboxamides and carbonitriles, preferably acrylamide and acrylonitrile; monoesters and diesters of fumaric acid and maleic acid such as the diethyl and diisopropyl esters and also maleic anhydride; ethylenically unsaturated sulfonic acids and salts thereof, preferably vinylsulfonic acid and 2-acrylamido-2-methylpropanesulfonic acid. Further examples are pre-crosslinking comonomers such as polyethylenically unsaturated comonomers, examples being diallyl phthalate, divinyl adipate, diallyl maleate, allyl methacrylate or triallyl cyanurate, or post-crosslinking comonomers, examples being acrylamidoglycolic acid (AGA), methylacrylamidoglycolic acid methyl ester (MAGME), N-methylolacrylamide (NMA), N-methylolmethacrylamide, N-methylolallylcarbamate, alkyl ethers such as the isobutoxy ether or esters of N-methylolacrylamide, of N-methylolmethacrylamide and of N-methylolallylcarbamate. Also suitable are epoxy-functional comonomers such as glycidyl methacrylate and glycidyl acrylate. Further examples are silicon-functional comonomers, such as acryloxypropyltri(alkoxy)- and methacryloxypropyltri(alkoxy)-silanes, vinyltrialkoxysilanes and vinylmethyldialkoxysilanes, where alkoxy groups present may be, for example, ethoxy and ethoxypropylene glycol ether radicals. Mention may also be made of monomers having hydroxyl or CO groups, examples being methacrylic and acrylic acid hydroxyalkyl esters such as hydroxyethyl, hydroxypropyl or hydroxybutyl acrylate or methacrylate and also compounds such as diacetoneacrylamide and acetylacetoxyethyl acrylate or methacrylate.

Preferred are copolymers of vinyl acetate with 1% to 50% by weight of ethylene; copolymers of vinyl acetate with 1% to 50% by weight of ethylene and 1% to 50% by weight of one or more further comonomers from the group of vinyl esters having 1 to 12 carbon atoms in the carboxyl radical such as vinyl propionate, vinyl laurate, vinyl esters of alpha-branched carboxylic acids having 9 to 13 carbon atoms such as VeoVa9, VeoVa10, VeoVa11; copolymers of vinyl acetate, 1% to 50% by weight of ethylene and preferably 1% to 60% by weight of (meth)acrylic esters of unbranched or branched alcohols having 1 to 15 carbon atoms, especially n-butyl acrylate or 2-ethylhexyl acrylate; and copolymers with 30% to 75% by weight of vinyl acetate, 1% to 30% by weight of vinyl laurate or vinyl esters of an alpha-branched carboxylic acid having 9 to 11 carbon atoms, and also 1% to 30% by weight of (meth)acrylic esters of unbranched or branched alcohols having 1 to 15 carbon atoms, especially n-butyl acrylate or 2-ethylhexyl acrylate which additionally contain 1% to 40% by weight of ethylene; copolymers with vinyl acetate, 1% to 50% by weight of ethylene and 1% to 60% by weight of vinyl chloride; where the polymers may additionally contain the stated auxiliary monomers in the stated amounts, and where the figures in % by weight add up to 100% by weight in each case.

Preference is also given to (meth)acrylic ester polymers, such as copolymers of n-butyl acrylate or 2-ethylhexyl acrylate or copolymers of methyl methacrylate with n-butyl acrylate and/or 2-ethylhexyl acrylate; styrene-acrylate copolymers with one or more monomers from the group of methyl acrylate, ethyl acrylate, propyl acrylate, n-butyl acrylate, 2-ethylhexyl acrylate; vinyl acetate-acrylate copolymers with one or more monomers from the group of methyl acrylate, ethyl acrylate, propyl acrylate, n-butyl acrylate, 2-ethylhexyl acrylate and optionally ethylene; styrene-1,3-butadiene copolymers; where the polymers may additionally contain the stated auxiliary monomers in the stated amounts, and where the figures in % by weight add up to 100% by weight in each case.

The most preferred are copolymers with vinyl acetate and 5% to 50% by weight of ethylene; or copolymers with vinyl acetate, 1% to 50% by weight of ethylene and 1% to 50% by weight of a vinyl ester of α-branched monocarboxylic acids having 9 to 11 carbon atoms; or copolymers with 30% to 75% by weight of vinyl acetate, 1% to 30% by weight of vinyl laurate or vinyl esters of an alpha-branched carboxylic acid having 9 to 11 carbon atoms, and also 1% to 30% by weight of (meth)acrylic esters of unbranched or branched alcohols having 1 to 15 carbon atoms which additionally contain 1% to 40% by weight of ethylene; or copolymers with vinyl acetate, 5% to 50% by weight of ethylene and 1% to 60% by weight of vinyl chloride.

The monomers and/or the weight fractions of the comonomers are selected so as to result in a glass transition temperature Tg of −25° C. to +35° C., preferably −10° C. to +25° C., more preferably −10° C. to +20° C. The glass transition temperature Tg of the polymers may be ascertained in a known manner via differential scanning calorimetry (DSC). The Tg may also be calculated approximately in advance via the equation of Fox. According to Fox T. G., Bull. Am. Physics Soc. 1, 3, page 123 (1956): 1/Tg=x1/Tg1+x2/Tg2+ . . . +xn/Tgn, where xn is the mass fraction (% by weight/100) of the monomer n, and Tgn is the glass transition temperature in kelvins of the homopolymer of the monomer n. Tg values for homopolymers are set out in Polymer Handbook, 2nd edition, J. Wiley & Sons, New York (1975).

The polymers are prepared generally in an aqueous medium and preferably by the emulsion or suspension polymerization process—as described for example in DE-A 102008043988. The polymerization may take place using the common protective colloids and/or emulsifiers, as described in DE-A 102008043988. The polymers in the form of aqueous dispersions may be converted as described in DE-A 102008043988 into corresponding water-redispersible powders. In that case in general a drying aid is used, preferably the abovementioned polyvinyl alcohols.

The polymers may be in the form, for example, of aqueous dispersions, more particularly of protective colloid-stabilized aqueous dispersions. Preferred protective colloids are polyvinyl alcohols, such as partly or fully hydrolyzed polyvinyl alcohols, more particularly with a degree of hydrolysis of 80 to 100 mol %. Particularly preferred are partly hydrolyzed polyvinyl alcohols having a degree of hydrolysis of 80 to 94 mol % and a Höppler viscosity in 4% aqueous solution of, in particular, 1 to 30 mPas (Höppler method at 20° C., DIN 53015). The stated protective colloids are accessible via processes known to the skilled person. The protective colloids are included generally in an amount of in total 1% to 20% by weight, relative to the total weight of polymers.

The polymers are preferably in the form of protective colloid-stabilized, water-redispersible powders. Dispersing of the protective colloid-stabilized, water-redispersible polymer powders leads to the protective colloid-stabilized polymers in the form of aqueous redispersions. The powders contain preferably 3% to 30% by weight, more preferably 5% to 20% by weight, of polyvinyl alcohols, more particularly the abovementioned polyvinyl alcohols, relative to the dry weight of the powders.

The protective colloid-stabilized polymers are generally present separately from the air entrainers and/or foam stabilizers. The air entrainers and/or foam stabilizers are generally not coated with the protective colloid-stabilized polymers. The protective colloid-stabilized polymers or protective colloids, or the polymers of the protective colloid-stabilized polymers, are generally different from the foam stabilizers and any thickeners.

Cement may comprise, for example, Portland cement (CEM I), Portland composite cement (CEM II), blast furnace cement (CEM III), pozzolanic cement (CEM IV), composite cement (CEM V), Portland silicate dust cement, Portland slate cement, Portland limestone cement, trass cement, magnesia cement, phosphate cement, mixed cements or filled cements or rapid-setting cement. Examples of rapid-setting cement are aluminate cement, calcium sulfoaluminate cements and high-alumina cement. Preference is given to Portland cement CEM I, Portland composite cement CEM II/A-S, CEM II/B-S, Portland limestone cement CEM II/A-LL, Portland fly ash cement CEM II/A-V, Portland fly ash composite cement CEM II/B-SV or blast furnace cement CEM III/A, CEM III/B, CEM III/B and aluminate cement.

The foam mortars are based on cement to an extent of preferably 40% to 95% by weight, more preferably 50% to 92% by weight, very preferably 60% to 91% by weight and most preferably 70% to 90% by weight, relative to the dry weight of the foam mortars.

In one preferred embodiment, the foam mortars comprise rapid-setting cement, such as aluminate cement, and also one or more cements other than rapid-setting cement, more particularly Portland cements. Rapid-setting cement is particularly advantageous for achieving the object of the invention.

The foam mortars are based on rapid-setting cement preferably to an extent of 1% to 30% by weight, more preferably 5% to 20% by weight and most preferably 10% to 15% by weight, relative to the dry weight of the foam mortars. The foam mortars are based on rapid-setting cement to an extent of preferably 1% to 40% by weight, more preferably 5% to 30% by weight and most preferably 10% to 20% by weight, relative to the total weight of the cement used overall.

The foam mortars may also comprise one or more thickeners, examples being polysaccharides such as cellulose ethers and modified cellulose ethers, cellulose esters, starch ethers, guar gum, xanthan gum, polycarboxylic acids such as polyacrylic acid and partial esters thereof, casein and associative thickeners. Preferred cellulose ethers are methylcellulose ethers. The thickeners are generally different from the foam stabilizers. The thickeners have molecular weights of preferably >4000 g/mol, more preferably ≥10 000 g/mol and most preferably ≥20 000 g/mol. The foam mortars are based on thickeners to an extent of preferably ≤5% by weight, more preferably 0.1% to 3% by weight and most preferably 0.5% to 1.5% by weight, relative to the dry weight of the foam mortars.

Moreover, the foam mortars may also comprise setting accelerators, such as aluminum compounds, silicates, alkali metal or alkaline earth metal hydroxides, nitrates, nitrites, sulfates, borates or of carboxylic acids. Preferred setting accelerators are aluminum salts, aluminates, alkali metal silicates, such as waterglass, alkali metal formates, potassium hydroxide or calcium hydroxide (Ca(OH)₂).

The foam mortars are based on setting accelerators to an extent of preferably 0.1% to 5% by weight, more preferably 0.2% to 2% by weight and most preferably 0.3% to 1% by weight, relative to the dry weight of the foam mortars.

The foam mortars may also comprise one or more pozzolans, such as for example kaolin, microsilica, diatomaceous earth, fly ash, trass flour, ground blast furnace slag, glass flour, precipitated silica and fumed silica. Preferred pozzolans are kaolin, microsilica, fly ash, ground blast furnace slag, especially metakaolin. The foam mortars are based on pozzolans to an extent for example of 0% to 10% by weight, preferably 0.5% to 5% by weight, relative to the dry weight of the foam mortars. Most preferably, the foam mortars contain no pozzolans.

The foam mortars are based on gypsum to an extent of preferably ≤30% by weight, more preferably ≤20% by weight, more preferably ≤10% by weight and very preferably ≤5% by weight, relative to the dry weight of the components for producing the foam mortars. Most preferably, the foam mortars contain no gypsum. Absence of gypsum leads to an improvement in the water resistance of the set foam mortar. Illustrative embodiments of gypsum are α- or ß-hemihydrate (CaSO₄·½ H₂O), dihydrate, anhydrite or the calcium sulfate from flue gas desulfurization (FGD gypsum).

The foam mortars may also comprise one or more fillers. Examples of fillers are quartz sand, quartz flour, sand, limestone flour, dolomite, clay, chalk, slag sand flour, white lime hydrate, talc or mica, rubber crumb or hard fillers, such as aluminum silicates, corundum, basalt and carbides, such as silicon carbide or titanium carbide. Preferred fillers are quartz sand, quartz flour, limestone flour, calcium carbonate, calcium magnesium carbonate (dolomite), chalk or white lime hydrate. Fillers have a particle sizing of preferably ≤2 mm, more preferably ≤1 mm.

The foam mortars are based on fillers to an extent of preferably ≤10% by weight, more preferably ≤5% by weight, relative to the dry weight of the foam mortars. Most preferably, the foam mortars contain no fillers.

The foam mortars may also comprise lightweight fillers. Lightweight fillers is a term generally for fillers having a low bulk weight, usually of less than 500 g/l. The lightweight fillers are preferably different from the abovementioned fillers. With particular preference, the foam mortars contain no fillers other than lightweight fillers. Typical lightweight fillers, on a synthetic or natural basis, are substances such as hollow glass microspheres, polymers such as polystyrene beads, aluminosilicates, silicon oxide, aluminum silicon oxide, calcium silicate hydrate, silicon dioxide, aluminum silicate, magnesium silicate, aluminum silicate hydrate, calcium aluminum silicate, calcium silicate hydrate, aluminum iron magnesium silicate, calcium metal silicate and/or volcanic slag. Preferred lightweight fillers are perlite, Celite, Cabosil, Circosil, Eurocell, Fillite, Promaxon, Vermex and/or wollastonite and also polystyrene.

The foam mortars are based on lightweight fillers to an extent of preferably 0% 10% by weight, more preferably 0.5% to 5% by weight and very preferably 1% to 3% by weight, relative to the dry weight of the foam mortars. Most preferably, the foam mortars contain no lightweight fillers.

The foam mortars may optionally also comprise additives, examples being plasticizers, superplasticizers, retardants, film-forming assistants, dispersants, hydrophobizing agents, pigments, preservatives, flame retardants (e.g., aluminum hydroxide) and finely divided silica. Preferred additives are plasticizers and superplasticizers. Additives are present preferably at 0% to 20% by weight, more preferably 0.1% to 10% by weight and most preferably 0.5% to 7% by weight, relative to the dry weight of the foam mortars.

The foam mortars preferably comprise no hexafluorosilicic acid, more particularly no salts of hexafluorosilicic acid, such as calcium, magnesium, zinc or ammonium salts.

The aqueous foam mortars are preferably produced using 4% to 30% by weight, more preferably 6% to 20% by weight and most preferably 8% to 15% by weight of water, relative to the dry weight of the foam mortars.

The aqueous foam mortars may be produced by mixing of their individual constituents in common mixing apparatuses, such as for example with mortar mixing assemblies, machine drill stirrers, dissolvers or mixing-coil stirrers, particularly at a high speed of the stirring or mixing assembly, preferably >150 rpm, more preferably from 150 to 1000 rpm. In this case, generally, air pores are incorporated into the foam mortar, using air entrainers and/or by introduction of air, for example, as already described earlier on above.

The foam mortars are preferably 1-component systems, meaning that preferably all of the constituents of the foam mortars are mixed in a mixing apparatus. More preferably, foam mortars are first produced in the form of dry mixtures, and water is added subsequently.

On addition of water, the foam mortars are mixed for preferably 1 to 10 minutes, more preferably 2 to 5 minutes. Mixing takes place preferably at 5 to 35° C., more preferably 15 to 25° C.

The foam mortar generally contains air pores. The foam mortar preferably has a cream-like or creamy consistency. The foam mortar has a density of preferably 0.1 to 1 g/cm³, more preferably 0.2 to 0.9 g/cm³ and most preferably 0.5 to 0.8 g/cm³. The density may be determined in a conventional way, for example by filling a container with a defined volume of the foam, and weighing.

Generally speaking, the resultant foam mortars are applied immediately after they have been produced, and in particular without a further processing step.

The foam mortars are used as bonding agents for floorings. The foam mortar is used generally to bond floorings to substrates. The floorings are laid in particular on horizontal surfaces or surfaces with a slight gradient. The foam mortar may be applied per se as when using conventional building adhesives. Accordingly, the aqueous foam mortars may be applied by machine, using a sprayer, for example, or preferably manually to a substrate, using a trowel, for example, and distributed, using a toothed trowel, for example. The flooring can then be laid on the foam mortar layer thus applied, and bonded to the substrate.

The foam mortar layer applied to the substrate has a thickness of preferably 0.5 to 8 mm, more particularly 2 to 4 mm.

After the foam mortar layer has cured, any joints can be filled using conventional joint filler, for example.

The foam mortar may be used to lay conventional floorings on the common substrates. Examples of substrates are aerated concrete, concrete, plaster or floor-filling compounds. Examples of floorings are natural stone floorings, ceramic floorings or plastic floorings, especially in the form of tiles, such as vinyl tiles, preferably ceramic tiles, natural stone tiles or glass tiles, for the exterior or, in particular, the interior, for example. Particularly preferred tiles are earthenware tiles, stoneware tiles, porcelain stoneware tiles, ceramic tiles or natural tiles, especially large-format tiles.

After 28 days under standard conditions (23° C., 50% relative humidity), the set foam mortar has a dry bulk density of preferably 10 to 1000 kg/m³, more preferably 100 to 800 kg/m³ (method of determination: based on EN 1015-6).

After 28 days under standard conditions (23° C., 50% relative humidity), the foam mortar (solid mortar) has a thermal conductivity of preferably 50 to 200 mW/mK, more preferably 30 to 100 mW/mK. The thermal conductivity is determined using the HFM 436 thermal conductivity instrument from Netzsch according to DIN EN 13163. The measurement is carried out with the Lambda 10° C. setting, the lower plate being set at 2.5° C. and the upper plate at 17.5° C. The test substrate is clamped in centrally and the measurement runs until the test substrate has reached a core temperature of 10° C.

Through the use of foam mortar in accordance with the invention as a bonding agent for laying floorings, considerable amounts of bonding agents—70%, for example—can be saved by comparison with corresponding use of conventional bonding agents. This is a considerable environmental and economic advantage and also reduces the cost and complexity involved in transporting construction adhesives to the building site and processing them there, so achieving a considerable boost to the productivity overall. Advantageously, the foam mortars are readily accessible and can be processed as with conventional adhesive mortars for the laying of floorings.

Surprisingly, the floors laid in accordance with the invention have surprisingly good mechanical properties, especially tensile adhesion strengths. Thus tiles laid in accordance with the invention also meet the C1 standard according to DIN 12004 and hence achieve tensile adhesion strengths of at least 0.5 N/mm², after dry storage or else after wet storage.

Furthermore, the foam mortars of the invention also display advantageous fresh-mortar properties and have, for example, a creamy consistency, this being highly prized by the user on application of the bonding agents, for reasons of ergonomics. The open time of the foam mortar is sufficient to allow laid floorings to be corrected.

The examples which follow serve for detailed explanation of the invention and should not in any way be understood as imposing any limitation.

### Production of a Foam Mortar as Tile Adhesive:

The amount of water indicated in table 1 was added to a dry mixture of the components set out in table 1, and, after 30 minutes of stirring with a Toni mixer (level 2), the ready-to-use foam mortar was obtained with cream-like consistency.

The resulting foam mortar was used as a tile adhesive.

To lay the tiles, the foam mortar was spread using a toothed trowel (6×6×6 comb application, layer thickness: around 4 mm) on a concrete slab. Glass tiles (measurements 40 cm×40 cm) were laid into the foam mortar bed with a joint width of 6 mm.

TABLE 1
Tile adhesive formula, Example 1:

| | Example 1 |
|---|---|
| | [parts by wt.] |
| Polymer powder | 80 |
| Tylose MH 60010 P4 | 3.5 |
| Hostapur OSB | 2 |
| Sodium hydrogencarbonate | 2 |
| Milke CEM \| 52.5R | 324.7 |
| Fondu Lafarge | 60 |
| Walhalla fine lime hydrate | 25 |
| Sodium carbonate | 2 |
| Tartaric acid (Merck) | 0.8 |
| Water | 65 |

### Components of the Tile Adhesive Formula:

Polymer powder:
Polyvinyl alcohol-stabilized, water-redispersible polymer powder of a vinyl acetate-ethylene copolymer having a glass transition temperature of 16° C.;
Tylose MH 60010 P4 (trade name belonging to Shin Etsu):
Etherified methylhydroxyethylcellulose (thickener);
Hostapur OSB (trade name belonging to Shin Etsu):
Sodium salt of a C14/C16-α-olefinsulfonic acid;
Milke CEM I 52.5R: Portland cement;
Fondu Lafarge (trade name belonging to Imerys):
Calcium aluminum cement (rapid-setting cement);
Walhalla fine hydrate:
Calcium hydroxide (Ca(OH)₂) (latent hydraulic binder).
   Testing of the Tiled Assembly from Example 1:

The wet density of the foam mortar was determined using a density measuring cup.

The open time was determined after 5, 20 and 30 minutes according to EN1348.

The tensile adhesion strength was determined after the storage conditions indicated in table 2, according to EN1348.

The results of testing are summarized in table 2.

TABLE 2
Results of testing with the foam mortar and the tiled
assembly of Example 1:

| | Example 1 |
|---|---|
| Wet density [g/cm³] | 0.66 |
| Open time [N/mm²]: | |
| 5 min | 0.54 |
| 20 min | 0.94 |
| 30 min | 1.21 |
| Tensile adhesion strength [N/mm²]: | |
| 28dSC^{a)} | 1.02 |
| 7dSC/21dWS^{b)} | 0.62 |
| 14dSC/14dDS^{c)} | 1.04 |
| 7dSC/21dWS/25*Freeze-thaw^{d)} | 0.69 |

^{a)}28dSC: testing after 28 days of storage under standard conditions;
^{b)}7dSC/21dWS: testing after 7 days of storage under standard conditions and 21 days of wet storage (at 23° C. in water);
^{c)}14dSC/14dDS: testing after 14 days of storage under standard conditions and 14 days of dry storage at 70° C.;
^{d)}7dSC/21dWS/25*Freeze-thaw: testing after 7 days of storage under standard conditions, 21 days of wet storage (at 23° C. in water) and 25 days of freeze-thaw storage.

1-13. (canceled)

14. The use of foam mortar as bonding agent for floorings, said foam mortar comprising protective colloid-stabilized polymers of ethylenically unsaturated monomers and one or more air entrainers selected from the group encompassing ammonium salts and alkali metal salts of hydrogencarbonates and carbonates, with the proviso that the foam mortar contains no fillers.

15. The use of foam mortar as bonding agent for floorings as claimed in claim 14, wherein the foam mortars are based on one or more foam stabilizers, cement, one or more protective colloid-stabilized polymers of ethylenically unsaturated monomers in the form of aqueous dispersions or water-redispersible powders, one or more air entrainers and optionally one or more additives.

16. The use of foam mortar as bonding agent for floorings as claimed in claim 14, wherein the foam mortars comprise sodium hydrogencarbonate as air entrainer.

17. The use of foam mortar as bonding agent for floorings as claimed in claim 15, wherein the foam stabilizers selected are
one or more surfactants selected from the group encompassing olefinsulfonic acids; fatty acids or salts thereof; fatty alcohols; alkylphenols or hydroxyalkylphenols; alkyl and alkylaryl ether sulfates; alkylsulfonates, alkylarylsulfonates; esters or monoesters of sulfosuccinic acid; phosphoric acid partial esters; alkyl polyglycol ethers; alkylaryl polyglycol ethers; ethylene oxide/propylene oxide (EO/PO) block copolymers; N-methyltauride; fatty acid alkylolamides; amine oxides; or phosphine oxides; sodium cocoyl dimethylaminoacetate; sulfobetaine and phosphoric esters; and/or
one or more polymers selected from the group encompassing polyvinyl alcohols; polyvinyl acetals; polyvinylpyrrolidones; polysaccharides in water-soluble form; lignosulfonates; poly(meth)acrylic acid; copolymers of (meth)acrylates with carboxyl-functional comonomer units; poly(meth)acrylamide; polyvinylsulfonic acids and water-soluble copolymers thereof, melamine-formaldehydesulfonates; naphthalene-formaldehydesulfonates; styrene-maleic acid copolymers; and vinyl ether-maleic acid copolymers; and/or
one or more proteins selected from the group encompassing casein, caseinate, soy protein; gelatin; and other proteins obtainable by protein hydrolysis of animal proteins; and/or enzymes of biotechnological origin.

18. The use of foam mortar as bonding agent for floorings as claimed in claim 14, wherein the foam mortars comprise one or more foam stabilizers selected from the group encompassing olefinsulfonic acids; fatty acids having 16 to 18 carbon atoms or salts thereof, fatty alcohols having 10 to 18 carbon atoms; alkylphenols or hydroxyalkylphenols having alkyl chains with 10 to 18 carbon atoms; alkyl and alkylaryl ether sulfates having 8 to 18 carbon atoms in the hydrophobic radical and 1 to 50 ethylene oxide units; alkylsulfonates having 8 to 18 carbon atoms; alkylarylsulfonates having alkyl radicals with 8 to 18 carbon atoms; and esters or monoesters of sulfosuccinic acid.

19. The use of foam mortar as bonding agent for floorings as claimed in claim 14, wherein the foam mortars are based on 5% to 40% by weight of protective colloid-stabilized polymers of ethylenically unsaturated monomers, relative to the dry weight of the foam mortars.

20. The use of foam mortar as bonding agent for floorings as claimed in claim 14, wherein the polymers of ethylenically unsaturated monomers are based on one or more monomers selected from the group encompassing vinyl esters, (meth)acrylic esters, vinylaromatics, olefins, 1,3-dienes and vinyl halides.

21. The use of foam mortar as bonding agent for floorings as claimed in claim 14, wherein polymers of ethylenically unsaturated monomers selected are one or more copolymers selected from the group encompassing copolymers with vinyl acetate and 5% to 50% by weight of ethylene; copolymers with vinyl acetate, 1% to 50% by weight of ethylene and 1% to 50% by weight of a vinyl ester of α-branched monocarboxylic acids having 9 to 11 carbon atoms; copolymers with 30% to 75% by weight of vinyl acetate, 1% to 30% by weight of vinyl laurate or vinyl esters of an alpha-branched carboxylic acid having 9 to 11 carbon atoms, and also 1% to 30% by weight of (meth)acrylic esters of unbranched or branched alcohols having 1 to 15 carbon atoms which additionally contain 1% to 40% by weight of ethylene; and copolymers with vinyl acetate, 5% to 50% by weight of ethylene and 1% to 60% by weight of vinyl chloride.

22. The use of foam mortar as bonding agent for floorings as claimed in claim 14, wherein the foam mortars are based to an extent of 1% to 40% by weight on rapid-setting cement, relative to the total weight of the cement comprised overall, said rapid-setting cement being selected from the group encompassing aluminate cement, calcium sulfoaluminate cements and high-alumina cement.

23. The use of foam mortar as bonding agent for floorings as claimed in claim 14, wherein the floorings are selected from the group encompassing natural stone floorings, ceramic floorings, glass floorings and vinyl floorings.

24. The use of foam mortar as bonding agent for floorings as claimed in claim 14, wherein floorings are selected from the group encompassing earthenware tiles, stoneware tiles, porcelain stoneware tiles, ceramic tiles and natural tiles.

25. A method for laying floorings, in which floorings are bonded with foam mortar as bonding agent to a substrate, said foam mortar comprising protective colloid-stabilized polymers of ethylenically unsaturated monomers and one or more air entrainers selected from the group encompassing ammonium salts and alkali metal salts of hydrogencarbonates and carbonates, with the proviso that the foam mortar contains no fillers.
